(19) United States
(12) Patent Application Publication
(10) Pub. No.: US 2001/0029847 A1
(43) Pub. Date: Oct. 18, 2001

(54) Rack for producing transport bundles of stacked lumber, and bundle production

(75) Inventor: Jamie S. Tweten, Belfair, WA (US)

Correspondence Address: Jonathan A. Bay, Attorney at Law, Ste. 314, 333 Park Central East, Springfield, MO, 65806, US

(73) Assignee: Lumber Buddy, Inc.

(21) Appl. No.: 09/747,787

(22) Filed: Dec. 21, 2000

Related U.S. Application Data
(60) Provisional application No. 60/171,712, filed on Dec. 22, 1999.

(51) Int. Cl. B65B 13/18; B30B 5/02

(52) U.S. Cl. 100/34; 100/1; 100/211

(57) ABSTRACT

A rack for producing transport bundles of stacked lumber comprises a deck over which is laid plural rows of dunnage-and-banding gutters. The which dunnage-and-banding gutters are arranged to define a major channel that has a bottom wall extending between spaced sidewalls and is sized to receive dunnage stock. Two by four lumber (4.5 cm by 9 cm) is common for dunnage stock. The dunnage-and-banding gutters also define a minor channel recessed in the major channel's bottom wall. The minor channel is sized to receive banding material such as strap. Preferably both the dunnage stock as well as the banding can be fed in axially from either open end of the gutters after the lumber has already been stacked up on top.

### CROSS-REFERENCE TO PROVISIONAL APPLICATION(S)

This application claims the benefit of U.S. Provisional Application No. 60/171,712, filed Dec. 22, 1999.

### BACKGROUND AND SUMMARY OF THE INVENTION

The invention generally relates to material handling apparatus and more particularly to a rack for producing transport bundles of stacked lumber as well the use of such rack in the production of such bundles. Additional aspects and objects of the invention will be apparent in connection with the discussion further below of preferred embodiments and examples.

It is an object of the invention to provide a rack for a lumber yard to facilitate producing transport bundles of stacked lumber gotten from a collection of diverse sources.

It is an alternate object of the invention that the above rack facilitate the successive handling and deposit of the lumber in the stack from any of the successive diverse sources by the heft of a forklift.

It is another object of the invention that the above rack be provided with structures to facilitate the addition of dunnage and accomplishment of banding during the process of producing and completing a transport bundle of stacked lumber.

These and other aspects and objects are provided according to the invention by a rack for producing transport bundles of stacked lumber. The rack comprises a frame deck propped up on feet, posts, and gutters as more particularly described below. The frame deck extends between at least spaced lateral members and spaced forward and rearward cross-members. Also, the rack has a pair of upright spaced posts that are mounted to the deck. The posts align in a generally vertical plane that defines a rear margin of the deck.

Moreover, the rack has plural elongated dunnage-and-banding gutters mounted to extend across the deck generally along a front to back axis. The dunnage-and-banding gutters are arranged to define a major channel that has a bottom wall extending between spaced sidewalls and is sized to receive dunnage stock. The dunnage-and-banding gutters also define a minor channel recessed in the major channel's bottom wall. The minor channel is sized to receive banding material that relative to the dunnage stock is relatively compact.

For example, the dunnage-and-banding gutters might be sized such that the major channels accept the axial sliding in of two by four (4.5 cm×9 cm) dunnage stock as the minor channels accept the axial sliding in of flat band material not probably wider than an inch (2.5 cm).

Given the foregoing, transport bundles of stacked lumber can be built from succesive loads of lumber deposited at successive times on the deck or the top of the stack on the deck by a forklift which preferably approaches from the rear of the rack. To do this, the loads are hefted over the posts and by the occasion of touchdown the forklift's forks are reaching through the posts. The posts thereafter afford the forklift counteraction against the lumber from shifting rearward as the forklift drags the forks out in reverse. Then, any completed bundle may be banded with or without dunnage and preferably lifted off from the front of the rack.

Optionally, the dunnage-and-banding gutters may be formed by a pair of opposed angles having spaced base flanges mounted opposite a gap from one another on a planar mounting surface such that the further-apart spaced upright flanges define the major channel's sidewalls as the co-planar base flanges generally define the major channel's bottom wall. That way, the gap between the spaced base flanges defines the minor channel.

The dunnage-and-banding gutters are preferably spaced up off the plane of the deck by a spacing structure which defines the planar mounting surface therefor. Such a spacing structure might be an inverted channel. The dunnage-and-banding gutters might be mounted to cross-members of the deck either for re-positioning or not to vary the number of gutters, the spacing between, as well as how long or short the gutters may be.

The posts are preferably removably mounted to lateral members of the deck. The posts might include rearward diagonal braces to strengthen how sturdily the posts can oppose a rearward force applied at a given elevation higher than the deck.

The feet to the deck are given lengths such that the deck occupies a plane either about parallel with the given ground elevation or else is tilted to decline relatively in the rear. The feet may have either a fixed length or are adjustable.

Additional aspects and objects of the invention will be apparent in connection with the discussion further below of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a rear perspective view of a rack in accordance with the invention, for producing transport bundles of stacked lumber;

FIG. 2 is a side elevation view of FIG. 1;

FIG. 3 is a top plan view of FIG. 2;

FIG. 4 is a front elevational view thereof; and,

FIG. 5 is an enlarged scale view of DETAIL V in FIG. 4.

### DETAILED DESCRIPTION OF THE PREFERRED EMBODIMENTS

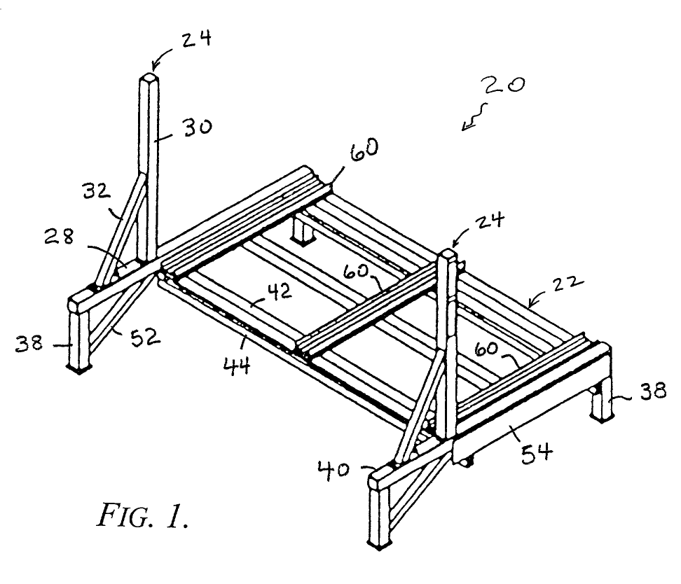

FIG. 1 is a perspective view of a rack 20 in accordance with the invention, for producing transport bundles of stacked lumber (not shown). In a preferred use environment, the rack 20 is utilized by way of non-limiting example in say wholesale or retail lumber yards. The rack 20 assists in multiple ways the process of the breaking apart of larger bundles of lumber stock, and the production therefrom of a particularized bundle which may be of diverse stock. Such a particularized bundle is likely a particular customer's order. The trouble of bundling it is undertaken for shipment as by trucking and the like.

The rack 20 provides more general utility on diverse job sites as a general-purpose lumber stacking apparatus. Diverse example usages and aspects of such use of the rack 20 will be more particularly described further below.

The rack 20 is preferably constructed very sturdy as the weight of lumber is tremendous in certain cases. For example, if the rack is constructed as a metal frame, it might weigh about 1,000 pounds (455 kg). A heavy frame like this can be moved around the lumber yard or job site or whatever by a forklift (eg., tow motor) or the like, but this is not shown.

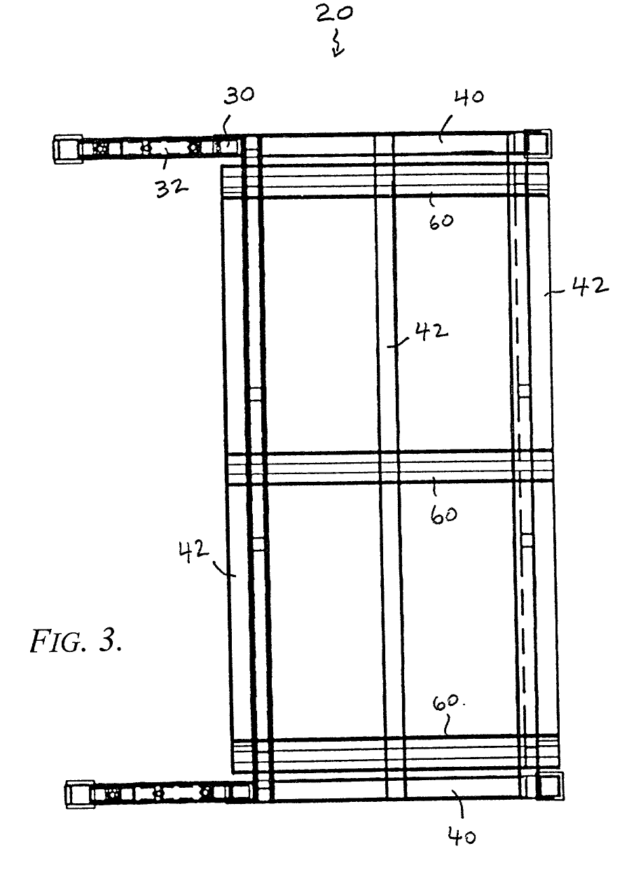

With general reference to FIGS. 1 through 4, the inventive rack 20 comprises a set of removably-connected sub-assemblies 22 and 24. Each sub-assembly 22 or 24 may be constructed by the fastening, welding or joining together of metal component pieces. These assemblies 22 and 24 comprise a main deck assembly 22 and a pair of post super-assemblies 24 set up on the back edge of the main deck 22. Each post super-assembly 24 comprises a footing 28, a post or mast 30 standing upright on the footing 28, and a brace 32 set an angle between the footing 28 and post 30 to strengthen the mounting of the upstanding post 30.

The braces 32 are preferred because they prop the posts 30 in the direction counter to the main applied force that the posts 30 must sustain. That is, a forklift ordinarily will deposit lumber on the deck 22 by approaching the deck 22 from the rear edge. To do this, the forklift must elevate the load all the way above the posts 30 to clear their tops and then deposit the load on the deck 22 by having the forks reaching through the posts 30. Once this is done, the forklift retracts its forks by reversing such that the posts 30 oppose the lumber from shifting backwards as the forks scrape out from underneath their load. Hence, the braces 32 prop the posts 32 in opposition to the lumber shifting rearwards with the forks while the forks are dragged out from behind in this process.

Each post 30 and brace 32 is preferably produced from square-tube stock as the footing 28 is preferably produced from flat-plate stock. All are preferably fixed together sufficiently sturdily as by welding or the like. The posts 30 might alternatively be produced with telescoping inner sleeves (not shown). Such telescoping inner sleeves would allows the posts to be given an adjustable greater height in cases when users would desire the extra height. The inner sleeves could be releasably fixed in place by thumb-tab headed set screws or the like twisted into threaded holes for them in the main or outer sleeve 30 (no set screws are shown, nor are inner sleeves).

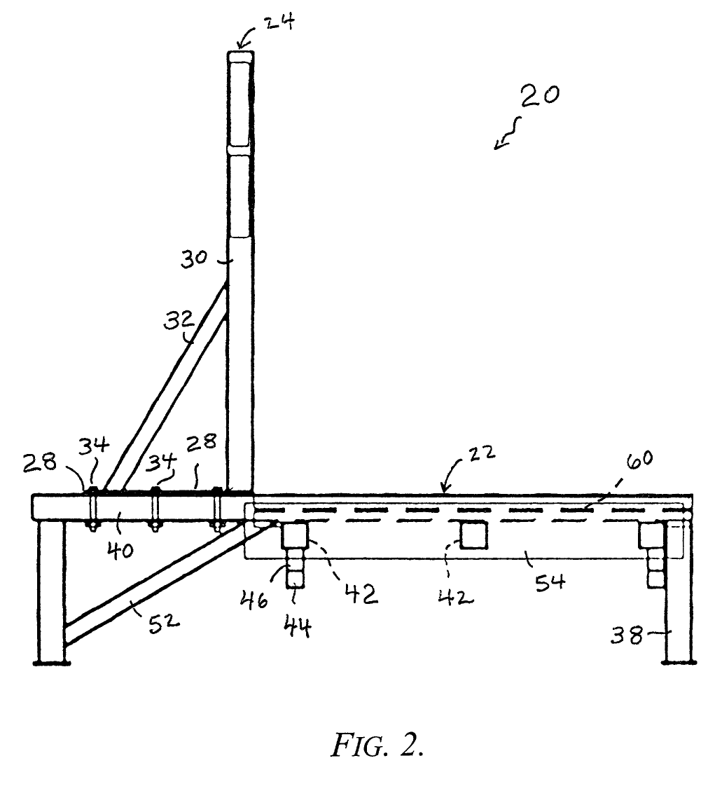

The post super-assemblies 24 are preferably removably connected to the main deck assembly (or sub-assembly) 22 by bolts 34 or other like fastening means. For one, easy connection and disconnection allows shipment of the rack 20 in a collapsed position (not shown) such that the rack 20 can be erected and bolted together in the erected position, as shown by the drawings, when the collapsed rack 20 reaches the job site. FIG. 2 shows the preferred mode of connecting the post super-assembly(ies) 24 to the main deck sub-assembly 22 to comprise bolts 34 through the footing 28 of the post super-assembly 24. For another reason, disconnection and re-connection affords the opportunity to move the post assemblies 24 about on the deck 22. It is advantageous that the post assemblies 24 can be erected in varying widths apart. This allows workers to change the gap between the posts 30, perhaps very narrow in some cases or wider in others. To do this, the support rack 20 would likely include a base board (not shown) lapped across and fastened down on the rearward extensions of siderails 40 as above struts 52. Such a base board (again, not shown) would preferably be pre-formed with bolts holes at given locations allowing incremental adjustment of the width between the post assemblies 24.

To turn to the main deck sub-assembly 22, it comprises four legs 38. The legs 38 prop up a pair of left and right side rails 40. Preferably the front legs are a bit longer than the rear legs. That way the deck 22 has a rearward tilt to it. Such a rearward tilt helps keep stacked lumber product leaning into the posts 30 at rest. Also, when a fork lift is reversing itself, dragging its forks from out between layers of stacked lumber, the rearward tilt helps keep the rack 20 standing in its place. That is, the rack 20's rear legs 38 ought to dig in the ground. A preferred option is either or both sets of front and back legs 38 are provided with an extensible lower leg (no such lower leg is shown). A way to achieve an extensible lower leg is to produce it out of a threaded rod which terminates in a foot. The bottom of the main leg 38 might be provided with a threaded hole in which the threaded-rod extensible foot twists in. That way, the tilt of the main deck 22 can be adjusted by twisting the threaded lower leg (again, not shown).

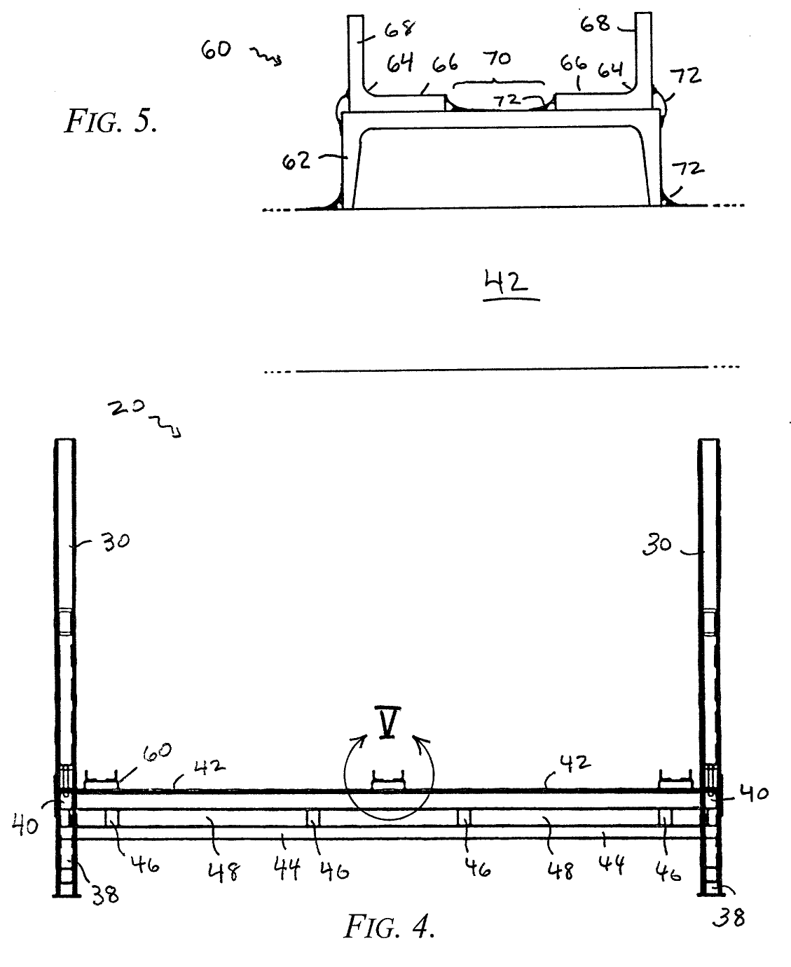

The span between the side rails 40 is fixed by a set of three spaced main deck members 42. Suspended from each of the front and back deck members 42 are full-width rungs 44, of which the front rung 44 is more clearly shown by the front elevational view of FIG. 4. The rungs 44 are suspended from each one's respective deck member 42 by a series of short hangers 46. The left and right openings 48 defined below the deck members 42 by the rungs 44 and hangers 46 operate as flat passages 48 for the removable insertion and retraction of the forks of a fork-lift and so on (not shown).

With reference to FIGS. 1 and 2, the rigidity between the legs 38 and side rails 40 is afforded extra support from struts 52 as well as stiffening plate 54. Each leg 38, side rail 40, deck member 42, rung 44, hanger 46 and strut 52 is preferably produced from square-tube stock, and all which are preferably fixed together sturdily as by fastening or welding and so on. The stiffening plate 54 is preferably produced from flat-plate stock and is likewise preferably attached sturdily by welding or fastening and the like.

The main deck members 42 carry on top of themselves a set of spaced dunnage gutters 60. Three such dunnage gutters 60 are shown. Each extends on axes parallel with the front to back direction. FIG. 5 shows a preferred format of construction of the dunnage gutters 60. The dunnage gutters 60 are propped up off the main deck members 42 by an inverted channel member 62. The web of the inverted channel 62 member carries a pair of angles 64 arranged such that the pair of angles 64 provide a pair of spaced base flanges 66 as well as a pair of further-spaced apart upright flanges 68. The upright flanges 68 cooperatively define the gutter walls for the dunnage gutter 60. The spacing between the base flanges 66 defines an open way 70 or passage-way for banding material.

Hence, the upright flanges 68 define a main channel for the nesting or axial sliding in of dunnage such as 2″×4″ runners or the like. In contrast, the much smaller sub-channel 70 defined between the in-turned base flanges 66 defines a banding sub-channel 70 which allows the nesting or axial sliding in of band strapping material. The dunnage gutters 60 are preferably produced from metal stock that allows welding at the weld-zones 72 indicated in FIG. 5.

Whereas FIG. 5 shows the dunnage gutters 60 welded to the deck member 42, alternatively the gutters 60 could be attached by fastening such as bolts or the like. The inverted channel piece 62 might be featured with little tabs or ears that lay flat on the deck piece 42 (such ears or tabs are not shown). The ears or tabs would likely be formed with holes for accepting a bolt that inserts through a complementary hole in the deck member 42. That way, the dunnage gutters 60 can be varied by number in use, the spacing between those put to use, as well as substituting for elongated gutters which might greatly extend beyond the front deck piece 42 in order to give the deck 22 a greater span in the front to back direction for certain applications, say for exceptionally wide panel products or the like (only one length of dunnage gutters 60 are shown).

Diverse example usages, as well as aspects of such use of the rack 20 include the following. The rack 20 ships in a collapsed condition such that the receiving party assembles the rack 20 in the erect position as for example shown by the drawings when received. This generally entails bolting together the disassembled base and super-assemblies 22 and 24.

The upright posts 30 allow a forklift to approach the rack 20 from the rear, elevate the lumber high up over the posts 30 and then deposit and stack the lumber either • on the dunnage gutters 60, if that is the first deposit on the rack, or • on lower layers of lumber if the current load is just being piled on earlier deposits on the rack 20. The posts 30 act to obstruct and stabilize the deposited lumber as the forklift drags its forks out from under lumber layers by reversing backwards away from the rack 20.

The dunnage gutters 60 are sized to accept two-by-four dunnage therein, as laid on a broad flat side (eg., two-by-fours being roughly equivalent to 5 cm×10 cm). However, the dunnage gutters can be sized as appropriate for whatever sizes most likely to be used by users. Indeed, it is preferred if the gutters 60 are slightly oversized to allow the axial sliding in of dunnage to be accomplished after when the bundle is already stacked up in place on the rack 20.

Banding material can be fed through the ways or sub-channels 70 for the banding material. The two-by-four dunnage and the lumber bundle piled up on top can all be strapped together by encircling bands—three for example—spaced on the spacing set by the dunnage gutters 60. This allows a forklift to approach the rack 20 preferably from the front and remove the bundle as for deposit on a flat bed and delivery thereafter. That is, while the forklift preferably builds a bundle predominantly by approaching the rack 20 from the rear, the forklift preferably removes a completed bundle from the front of the rack 20.

The elevation of the dunnage gutters 60 above ground level preferably measures about eighteen inches (45 cm) for the comfort of workers who manually pile and unpile lumber on and off the rack 20. This height is preferable for limiting the flexion of the back to a relatively powerful and safe position to handle lumber. If a whole lot lower, the workers might have to stoop over to relatively disadvantageous positions.

The rack 20 is sufficiently sturdy and strong for a forklift to deposit an entire, complete unit of lumber on it. Some units of lumber are so heavy that it might crush a less sturdy design. Nevertheless, the rack 20 is sufficiently sturdy to withstand the weight of heavy bundles. That way, after the heavy bundle has been deposited on the stand, the forklift operator might separate the bundle once there, and remove away upper layers that don't belong to that particular customer's order. The forklift operator can countdown from the top of the bundle how many layers he or she needs to go down in order to remove away the proper amount. Additionally, the posts might be labeled with measure indicia to give the forklift operator an external reference.

Also, the fork passages 48 (see FIG. 4) are spaced to promote stable transport of the rack 20 on a forklift.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A rack for producing transport bundles of stacked lumber, comprising:
a frame base comprising a deck and feet, wherein the deck extends between at least spaced lateral members and spaced forward and rearward cross-members, the feet propping the deck up off a given ground elevation;
a pair of upright spaced posts mounted to the deck and which align in a generally vertical plane that defines a rear margin of the deck;
plural elongated dunnage-and-banding gutters mounted to extend across the deck generally along a fore to rear axis, which dunnage-and-banding gutters are arranged to define a major channel that has a bottom wall extending between spaced sidewalls and is sized to receive dunnage stock, as well as define a minor channel recessed in the major channel's bottom wall, which minor channel is sized to receive banding material that relative to the dunnage stock is relatively compact;
whereby transport bundles of stacked lumber can be built from successive loads of lumber deposited at successive times on the deck or the top of the stack on the deck by a forklift which preferably approaches from the rear of the rack, such that the loads are lifted over the posts and by the instance of touchdown the forklift's forks are reaching through the posts, the posts thereafter affording the forklift counteraction against the lumber from shifting rearward as the forklift drags the forks out in reverse, and whereby the completed bundle may be banded with or without dunnage and preferably lifted off from the front of the rack.

2. The rack of claim 1 wherein the dunnage-and-banding gutters are formed by a pair of opposed angles having spaced base flanges mounted opposite a gap from one another on a planar mounting surface such that the further-apart spaced upright flanges define the major channel's sidewalls as the co-planar base flanges generally define the major channel's bottom wall, while the gap between the spaced base flanges defines the minor channel.

3. The rack of claim 1 wherein the dunnage-and-banding gutters are mounted for either re-positioning or not to cross-members of the deck.

4. The rack of claim 1 wherein the posts are removably mounted to lateral members of the deck.

5. The rack of claim 4 wherein the posts include rearward diagonal braces to strengthen how sturdily the posts can oppose a rearward force applied at a given elevation higher than the deck.

6. The rack of claim 1 wherein the feet are given lengths such that the deck occupies a plane either about parallel with the given ground elevation or else is tilted to decline relatively in the rear.

7. The rack of claim 6 wherein the feet have either a fixed length or are adjustable.

8. The rack of claim 1 further comprising spaced fork passages formed underneath the deck and for use by a forklift approaching from either the rear or front in order to facilitate the transport of the rack by the heft of the forklift.

9. The rack of claim 1 wherein the dunnage-and-banding gutters are sized such that major channels accept the axial sliding in of two by four (4.5 cm×9 cm) dunnage stock and the minor channels accept the axial sliding in of flat band material not wider than an inch (2.5 cm).

10. A rack for producing transport bundles of stacked lumber, comprising:
a base comprising a deck and feet, wherein the deck extends between at least spaced lateral margins and spaced forward and rearward margins, the feet propping the deck up off a given ground elevation;
a pair of upright spaced blocking members mounted to the deck and which align in a generally vertical plane that defines the rear margin of the deck;
plural elongated dunnage-and-banding gutters mounted to extend across the deck generally along a fore to rear axis, which dunnage-and-banding gutters are arranged to define a major channel that has a bottom wall extending between spaced sidewalls and is sized to receive dunnage stock, as well as define a minor channel recessed in the major channel's bottom wall, which minor channel is sized to receive banding material that relative to the dunnage stock is relatively compact;
whereby transport bundles of stacked lumber can be built from successive loads of lumber deposited at successive times on the deck or the top of the stack on the deck by a forklift which preferably approaches from the rear of the rack, such that the loads are lifted over the blocking members and by the instance of touchdown the forklift's forks are reaching through the blocking members, the blocking members thereafter affording the forklift counteraction against the lumber from shifting rearward as the forklift drags the forks out in reverse, and whereby the completed bundle may be banded with or without dunnage and preferably lifted off from the front of the rack.

11. The rack of claim 10 wherein the dunnage-and-banding gutters are formed by a pair of opposed angles having spaced base flanges mounted opposite a gap from one another on a planar mounting surface such that the further-apart spaced upright flanges define the major channel's sidewalls as the co-planar base flanges generally define the major channel's bottom wall, while the gap between the spaced base flanges defines the minor channel.

12. The rack of claim 11 wherein the dunnage-and-banding gutters are spaced up off the plane of the deck by a spacing structure which defines the planar mounting surface therefor.

13. The rack of claim 12 wherein the spacing structure comprises an inverted channel.

14. The rack of claim 10 wherein the dunnage-and-banding gutters are mounted for either re-positioning or not to cross-members of the deck.

15. The rack of claim 10 wherein the blocking members are removably mounted to lateral members of the deck.

16. The rack of claim 15 wherein the blocking members include rearward diagonal braces to strengthen how sturdily the blocking members can oppose a rearward force applied at a given elevation higher than the deck.

17. The rack of claim 10 wherein the feet are given lengths such that the deck occupies a plane either about parallel with the given ground elevation or else is tilted to decline relatively in the rear.

18. The rack of claim 18 wherein the feet have either a fixed length or are adjustable.

19. The rack of claim 10 further comprising spaced fork passages formed underneath the deck and for use by a forklift approaching from either the rear or front in order to facilitate the transport of the rack by the heft of the forklift.

20. The rack of claim 10 wherein the dunnage-and-banding gutters are sized such that major channels accept the axial sliding in of two by four (4.5 cm×9 cm) dunnage stock and the minor channels accept the axial sliding in of flat band material not wider than an inch (2.5 cm).
